(19) United States
(12) Patent Application Publication
(10) Pub. No.: US 2008/0304023 A1
(43) Pub. Date: Dec. 11, 2008

(54) Tilting actuator for light-projection

(76) Inventor: Hyun Cheal Bang, Ansan-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,018

(22) Filed: Jun. 6, 2007

(51) Int. Cl. G03B 21/28

(52) U.S. Cl. 353/98

(57) ABSTRACT

Disclosed herein is a tilting actuator for light-projection. The actuator comprises a mirror for reflecting light being projected from a light source, a tilting portion on which the mirror rests, a support portion, a hinge portion formed to connect the tilting portion and the support portion with each other, and a driver portion for tilting the tilting portion about the tilting axis with respect to the support portion. The hinge portion is disposed on a tilting axis of the tilting portion. The hinge portion has a ‘+’ shaped cross-section.

### FIELD OF THE INVENTION

The present invention relates to a titling actuator for light-projection, more specifically to a tilting actuator for tilting a light-reflecting mirror in a projection system.

### BACKGROUND OF THE INVENTION

Projection systems are used to display small images on a large screen using optical devices. The projection system is classified as a CRT (Cathode Ray Tube) projection, a LCD (Liquid Crystal Display) projection, and a DLP (Digital Light Processing) projection according to the types of image display elements.

The CRT projection system, which is the oldest method, displays images on a screen by reflecting images of a small high-resolution cathode ray tube onto a mirror. In the LCD projection system, a small LCD of about 4 inches within a projection TV receives external image signals and reproduces the images. Thereafter, the images displayed on a screen are exposed by a strong beam behind the liquid crystal display so that the display is magnified and reflected on a mirror so as to be projected on the screen.

The DLP projection system operates in such a way as to magnify and project externally input image signals using DMD (Digital Micro-mirror Device) semiconductor chip, in which hundreds of thousands of minute mirrors are integrated.

Such a DLP projection system is disclosed in U.S. Pat. No. 6,582,080 to Imax Corporation.

FIG. 1 shows schematically major elements of a conventional projection system. Reference numeral 20 denotes a light source which projects light beam 22 on a projection screen 24 via a projection lens 26. The light beam 22 is optically dissolved into red, green and blue components (R, G, B) by a beam-splitter comprising an assembly of prisms 30. The respective components are directed to three corresponding DMDs 32 by the beam-splitter.

The DMDs are identical but deal with different portions of the spectrum. In other words, the light that enters the beam-splitter is split into red, green and blue components, which are delivered to the respective red, green and blue DMDs. Thereafter, the beam-splitter re-assembles the red, green and blue components of the light beam and directs them together into the projection lens 26 for projection on the screen 24.

The individual DMD 32 includes an array of reflective digital light switches (mirrors) that are integrated onto a silicon chip capable of addressing the switches individually. Each switch represents a single pixel in the array and can be individually switched on or off, in response to digital information provided to the chip from an appropriate hardware and software controller. Each individual pixel in each DMD is controlled to impart appropriate image information to the light beam being projected onto the screen 24.

However, since the conventional projection system basically magnifies and projects original small images to be displayed on a large screen, it has a disadvantage that the enlarged image is inevitably degraded in its quality as compared with the original one.

In addition, the conventional DLP projection system embraces a problem that the image quality degrades due to an optical illusion.

### SUMMARY OF THE INVENTION

The present invention has been made in order to solve at least part of the problems in the art. It is an object of the invention to provide a tilting actuator for tilting a light-reflecting mirror in a projection system.

In order to accomplish the above objects, according to one aspect of the invention, there is provided a tilting actuator for light-projection. The actuator comprises a mirror for reflecting light being projected from a light source, a tilting portion on which the mirror rests, a support portion, a hinge portion formed to connect the tilting portion and the support portion with each other, the hinge portion being disposed on a tilting axis of the tilting portion, and a driver portion for tilting the tilting portion about the tilting axis with respect to the support portion.

In an embodiment, the hinge portion has a ‘+’ shaped cross-section.

In an embodiment, the driver portion includes a magnet fixed to one of the tilting portion and the support portion, and a wound coil fixed to the other one of the tilting portion and the support portion. When an electric current is applied to the wound coil, the wound coil reacts with magnetic flux from the magnet so as to tilt the tilting portion.

In an embodiment, the driver portion further includes a yoke for returning the magnetic flux into the magnet via the wound coil. The yoke has a support supporting the magnet and a support disposed in the centre of the wound coil, both of which are integrally formed.

In an embodiment, a bracket is combined to the support portion. The bracket has a plurality of adjustment screws for adjusting an initial set-up angle of the support portion.

In another embodiment, a bracket is combined to the support portion. The bracket has a PCB fixed thereto where a driver element for controlling an electric current being supplied to the wound coil.

### BRIEF DESCRIPTION OF THE DRAWINGS

Further objects and advantages of the invention can be more fully understood from the following detailed description taken in conjunction with the accompanying drawings in which:

FIG. 1 schematically shows a conventional projection system;

FIG. 2 is a sectional view of a conventional tilting device;

FIG. 3 is a schematic sectional view of a tilting actuator according to an embodiment of the invention; and

FIG. 4 is an exploded perspective view of the tilting actuator of FIG. 3.

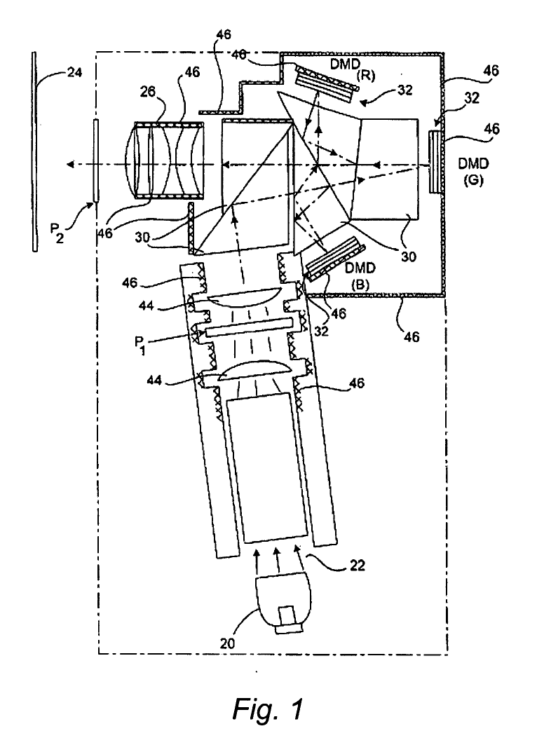

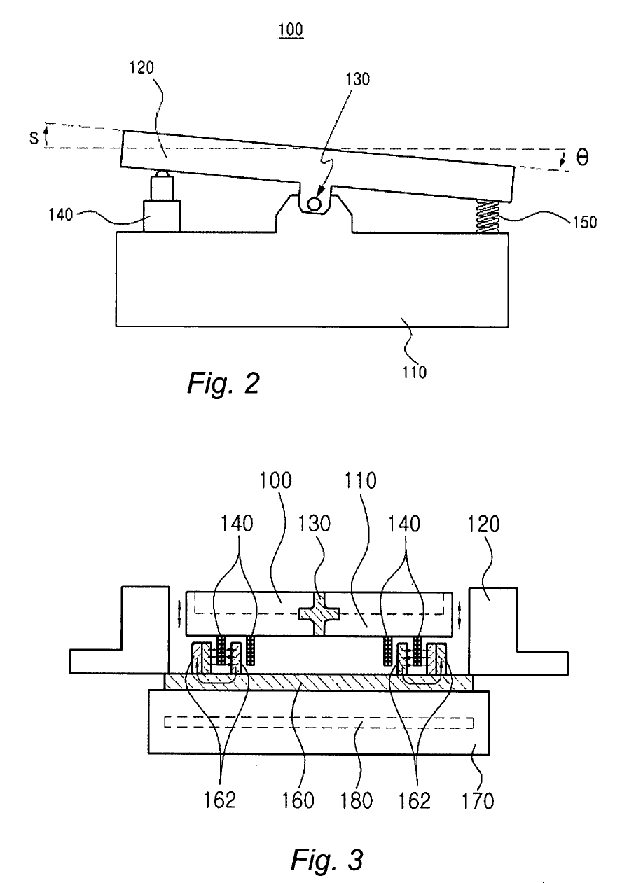

### DETAILED DESCRIPTION OF THE EXEMPLARY EMBODIMENTS OF THE INVENTION

Hereafter, exemplary embodiments of the invention will be explained, with reference to the accompanying drawings.

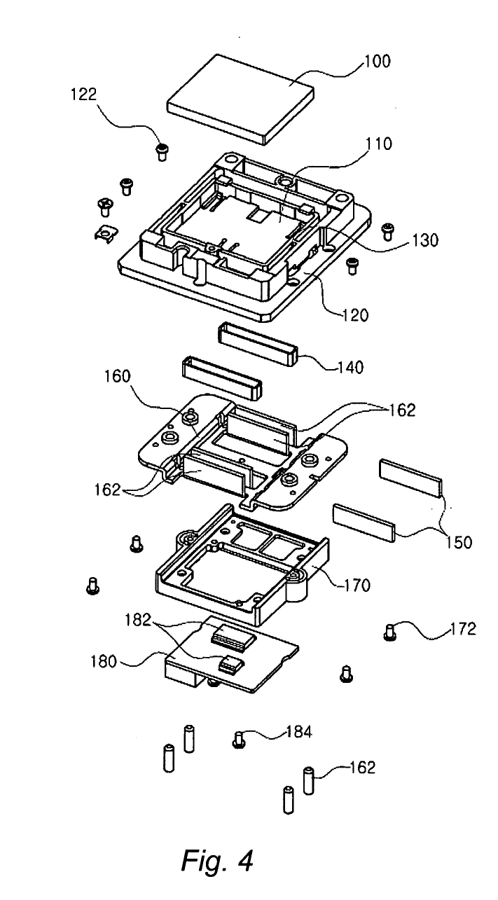

FIG. 3 is a schematic sectional view of a tilting actuator according to an embodiment of the invention. FIG. 4 is an exploded perspective view of the tilting actuator of FIG. 3.

In this embodiment, the tilting actuator includes a mirror 100 for reflecting light being projected from a light source, a tilting portion 110 where the mirror 100 rests, a support portion 120, a hinge portion 130 connecting the tilting portion 110 with the support portion 120, and a driver portion for tilting the tilting portion 110 with respect to the support portion 120. The hinge portion 130 is formed on the tilting axis of the tilting portion 110. The driver portion is disposed so as to enable to tilt the tilting portion 120 about the tilting axis thereof.

The tilting portion 110, the hinge portion 130 and the support portion 120 may be formed integrally with another using the same material. The hinge portion 130 may be made of an aluminum material or plastic material, which elastically responds to an external force, i.e., can be elastically deformed and restored into its original position in response to an external force.

The hinge portion 130 may have a ‘+’ shaped cross-section so as to provide a further restoring force.

The tilting portion 110 is designed to tilt in a fine way about the tilting axis of the tilting portion 110 that passes through the hinge portions 130. The mirror 100 attached to the tilting portion 110 also tilts in a fine and precise way accordingly to the tilting of the tilting portion 110.

The driver portion is composed of a magnet 150 fixed to either one of the tilting portion 110 and the support portion 120 and a wound coil 140 fixed to the other one of the tilting portion 110 and the support portion 120. When an electric power is applied to the wound coil 140, the wound coil 140 interacts with the magnetic flux from the magnet 150 to thereby generate a driving force for tilting the tilting portion 110.

As shown in FIG. 3, in this embodiment the magnetic flux of the magnet 150 passes through the wound coil 140 in the horizontal direction. The electric current of the coil 140 flows in the horizontal direction, but perpendicularly to the magnetic flux of the magnet 150. Thus, when an electric power is applied to the coil 140, an electromagnetic force is generated according to Fleming's left hand rule. That is, since the magnet 150 is fixed to the support portion 120, the coil 140 moves up and down to thereby tilt the tilting portion 110 to which the coil 140 is fixed.

Referring to FIGS. 3 and 4, the above driver portion is disposed at both sides of the tilting axis of the tilting portion 130.

The two driver portions are configured so as to generate a driving force in opposite direction to each other to thereby facilitate the tilting motion of the tilting portion 110.

In addition, the respective driver portion may further include a yoke 160 configured so as to return the magnetic flux to the magnet after it passes through the coil 140. The yoke 160 is formed of a material capable of transmitting magnet flux. The yoke 160 includes a support plate 162 supporting the magnet 150 and another support plate 162 being positioned in the center of the wound coil 140, which are formed integrally with the yoke.

The support portion 120 and the yoke 160 are attached to each other using a first fastener screw 122.

A bracket 170 is attached to the support portion 120. The bracket 170 is provided with a plurality of adjustment screws 162 for adjusting initial setup angles of the support portion 120. The bracket 170 is fixed to the yoke 160 by means of a second fastener screw 172.

Furthermore, the bracket 170 is provided with a printed circuit board (PCB) 180 on which a driver element 182 for controlling the electric power being supplied to the coil 140 is mounted. The PCB is fixed to the yoke 160 by means of the third fastener screw 184.

Hereafter, operation of the above-configured tilting actuator will be explained.

Light emitted from a light source (e.g., a light scanning device) is reflected on the mirror 100 and travels towards a screen.

At this time, if an electric power is supplied to the coil 140 via the driver element 182, the coil 140 interacts with the magnetic flux of the magnet 150 such that a driving force is generated so as to move the coil 140 upwards and downwards and then tilt the tilting portion 110. If the electric current being supplied to the coil 140 is made to flow in opposite direction, the driving force is exerted on the tilting portion in opposite direction. As shown in FIG. 3, the magnetic flux passing through the coil 140 is returned to the magnet 150 via the yoke 160 and the support plates 162.

Accordingly, the tilting portion 110 and the mirror 100 attached thereto are tilted about the hinge portion 130 and restored into its original position repeatedly in a fine and precise manner.

As the mirror 100 is driven in a fine and delicate manner, the respective pixels of an image, which is reproduced and displayed on the screen by light reflected by the mirror, are overlapped with adjacent pixels to thereby result in a blurred pixel boundary. Therefore, according to a viewer's optical illusion, the screen can be recognized as a clear image by the viewer.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

What is claimed is:

1. A tilting actuator for light-projection, the actuator comprising:
a mirror for reflecting light being projected from a light source;
a tilting portion on which the mirror rests;
a support portion;
a hinge portion formed to connect the tilting portion and the support portion with each other, the hinge portion being disposed on a tilting axis of the tilting portion; and
a driver portion for tilting the tilting portion about the tilting axis with respect to the support portion.

2. The actuator as claimed in claim 1, wherein the hinge portion has a ‘+’ shaped cross-section.

3. The actuator as claimed in claim 3, wherein the driver portion includes a magnet fixed to one of the tilting portion and the support portion, and a wound coil fixed to the other one of the tilting portion and the support portion, wherein when an electric current is applied to the wound coil, the wound coil reacts with magnetic flux from the magnet so as to tilt the tilting portion.

4. The actuator as claimed in claim 3, wherein the driver portion further includes a yoke for returning the magnetic flux into the magnet via the wound coil, the yoke having a support supporting the magnet and a support disposed in the centre of the wound coil both of which are integrally formed.

5. The actuator as claimed in claim 1, wherein a bracket is combined to the support portion, the bracket having a plurality of adjustment screws for adjusting an initial set-up angle of the support portion.

6. The actuator as claimed in claim 3, wherein a bracket is combined to the support portion, the bracket having a PCB fixed thereto where a driver element for controlling an electric current being supplied to the wound coil.
